(19) United States
(12) Patent Application Publication
(10) Pub. No.: US 2024/0351083 A1
(43) Pub. Date: Oct. 24, 2024

(54) SHAPE CHECKING DEVICE FOR BENDING MATERIAL AND CONTINUOUS FORMING MACHINE

(71) Applicant: POSCO Co., Ltd., Pohang-si (KR)

(72) Inventor: Jae-Wook Lee, Incheon (KR)

(73) Assignee: POSCO Co., Ltd., Pohang-si (KR)

(21) Appl. No.: 18/135,934

(22) Filed: Apr. 18, 2023

(51) Int. Cl. B21C 51/00; B21D 22/20

(52) U.S. Cl. CPC B21C 51/00; B21D 22/20

(57) ABSTRACT

The present invention provides a shape checking device for a bending material including: a material fixing unit including a support member in which a first surface of a material including a first surface and a second surface, bent from the first surface is seated, and a pressing member configured to press the first surface of the material; and a distance measuring unit, and measuring a distance to the second surface, wherein the distance measuring unit includes a first distance measuring device for measuring a distance to the second surface, and a second distance measuring device for measuring a distance to a second surface, which is the same as the second surface on which a distance thereof is measured by the first distance measuring device, in a position, spaced apart from the first distance measuring device in a first direction, different from a bending forming direction of a material.

### TECHNICAL FIELD

The present disclosure relates to a shape checking device for a bending material and a forming machine including the same.

### BACKGROUND ART

In an automobile industry, application of a bending method is increasing due to the trend of increasing the strength of materials. Spring back, which in inevitable in bending materials, is a phenomenon caused by complex causes such as elastic modulus of the material, stress distribution in a thickness direction, and the like, and it is not easy to accurately predict and correct the same.

Due to springback, dimensional errors may occur, and it may be difficult to secure shape freezing when there is physical property deviation between coils. For example, an object such as a high-strength coil steel sheet may have a different internal stress from a sample before being formed due to a position in which the material is wound, a difference in winding tension, or the like, so that even if it is formed with the same mold, an effect of the targeted springback correction may not be achieved, and thus, a process of checking a dimension after forming a final product, is required.

FIG. 1 schematically illustrates a conventional forming dimension checking device for a final product. The forming dimension checking device for a final product overlaps a formed product 2 on a product 1 having a target shape, and fixes the two products through a clamp 3. The clamp 3 clamps a portion, not requiring separate measurement because it is easy to secure a joint point with other parts or dimensions. The dimensions of the clamped product are measured through a gap gauge 4.

As described above, when the dimensions measured through the gauge 4 is out of tolerance, it is classified as a defective product, and when a defective product occurs, a mold correction or a post process (re-strike) should be added.

Most of these dimensional measurement operations are performed manually, so there is a problem in that time, space, and personnel are required.
(Patent Document 1) KR 10-2178739 B

### SUMMARY OF INVENTION

### Technical Problem

An aspect of the present disclosure is to provide a shape checking device for a bending material for measuring a formation error due to springback of a material and a forming machine including the same to solve the above problems of the prior art.

### Solution to Problem

An aspect of the present disclosure is to provide a shape checking device for a bending material and a forming machine as follows in order to achieve the above object.

According to an aspect of the present disclosure, provided is a shape checking device, the shape checking device including: a material fixing unit including a support member on which a first surface of a material including a first surface and a second surface, bent from the first surface is seated, and a pressing member configured to press the first surface of the material seated on the support member; a distance measuring unit connected to the support member, and measuring a distance to the second surface, wherein the distance measuring unit includes a first distance measuring device for measuring a distance to the second surface, and a second distance measuring device for measuring a distance to the second surface, which is the same as the second surface on which a distance thereof is measured by the first distance measuring device, in a position, spaced apart from the first distance measuring device in a first direction, different from a bending forming direction of the material.

According to an aspect of the present disclosure, a shape inferring unit connected to the distance measuring unit, and inferring a shape of a material from a result measured by the distance measuring unit is further included, wherein the shape inferring unit may calculate distortion generated in the material based on a result measured by the first distance measuring device and a result measured by the second distance measuring device.

According to an aspect of the present disclosure, provided is a forming machine for continuously forming and checking a shape of a material including a plurality of forming portions and a connection portion surrounding the forming portions, the forming machine including: a first forming device for preliminarily forming by bending a forming portion; a second forming device disposed adjacently to the preliminarily-formed device, and re-forming the preliminarily-formed forming portion; a shape checking device for checking a shape of the forming portion, formed by the second forming device; and a material transfer device for sequentially moving the material to the first forming device, the second forming device, and the shape checking device, wherein the shape checking device is the shape checking device for a bending material described above, and the second forming device includes a forming control unit for controlling a degree of bending forming in at least two points, spaced apart from one surface in a direction of transfer of the material in consideration of a measurement value of the shape checking device.

### Advantageous Effects of Invention

As set forth above, according to an embodiment of the present disclosure, a shape checking device for a bending material for measuring a formation error due to springback of a material through the above-described configuration and a forming machine including the same may be provided.

In addition, in the present disclosure, a shape checking device for a bending material for accurately and quickly measuring a shape of the bending material and a forming machine including the same, for accurately forming the bending material may be provided.

### BRIEF DESCRIPTION OF DRAWINGS

FIG. 1 is an image of a conventional forming dimension checking device.

FIG. 2 is a schematic view of a formed product.

FIG. 3 is a front view of a shape measuring device for a bending material according to a first embodiment of the present disclosure.

FIG. 4 is a side view of a shape measuring device for a bending material according to a first embodiment of the present disclosure.

FIG. 5 is a plan view of a shape measuring device for a bending material according to a first embodiment of the present disclosure.

FIGS. 6A and 6B are schematic operation diagram of a shape measuring device for a bending material according to an embodiment of the present disclosure, FIG. 6A is a schematic diagram of a state before measurement, and FIG. 6B is a schematic diagram of a state during measurement.

FIG. 7 is a front view of a shape measuring device for a bending material according to a second embodiment of the present disclosure.

FIG. 8 is a side view of a shape measuring device for a bending material according to a second embodiment of the present disclosure.

FIG. 9 is a plan view of a shape measuring device for a bending material according to a second embodiment of the present disclosure.

FIG. 10 is a flowchart of an operation of a shape measuring device for a bending material according to the present disclosure.

FIG. 11 is a schematic diagram of a forming machine including a shape measuring device for a bending material according to the present disclosure.

FIG. 12 is a plan view of a material passing through the forming machine of FIG. 11.

FIG. 13 is a schematic diagram of a second forming device of the forming machine of FIG. 11.

FIG. 14 is a graph of a final shape of a forming machine including a shape measuring device for a bending material according to the present disclosure.

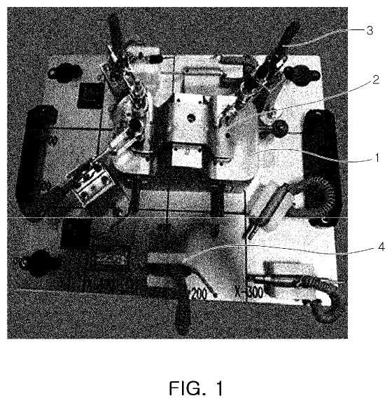

### MODE FOR INVENTION

Hereinafter, preferred embodiments will be described in detail so that those skilled in the art can easily practice the present invention with reference to the accompanying drawings. However, in describing a preferred embodiment of the present disclosure in detail, if it is determined that a detailed description of a related known function or configuration may unnecessarily obscure the gist of the present disclosure, the detailed description will be omitted. In addition, the same reference numerals are used throughout the drawings for parts having similar functions and actions. In addition, in the present specification, terms such as ‘upper’, ‘upper portion’, ‘upper surface’, ‘lower’, ‘lower portion’, ‘lower surface’, and ‘side surface’ are based on the drawings, and may actually vary depending on a direction in which elements or components are disposed.

In addition, throughout the specification, when it is said that a portion is ‘connected’ to another portion, which includes not only a case in which it is ‘directly connected’, but also a case in which it is ‘indirectly connected’ with another element interposed therebetween. In addition, ‘including’ a certain component means that other components may be further r included, rather than excluding other components unless otherwise stated.

In the present disclosure, an X-direction refers to a bending forming direction (a direction in which a direction is reduced by forming) or a left-right direction, and a Y-direction refers to a direction perpendicular to the bending forming direction on a horizontal plane, that is, a direction in which a material is supplied and a forwards-backwards direction, and a Z-direction refers to a height direction.

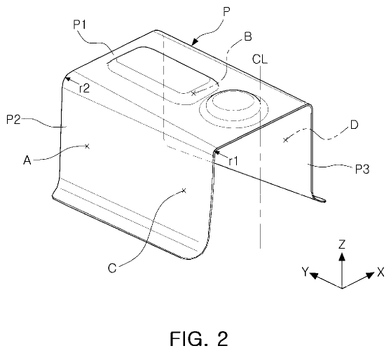

FIG. 2 illustrates a schematic diagram a forming material P. As shown in FIG. 2, since bending forming is performed, a first surface P1 to which a material P is fixed during bending forming and a second surface P2 and a second surface P3 to be formed by bending on both sides around the first surface P1 are located. The second surfaces P2 and P3 are formed by bending with respect to the first surface P1 according to a longitudinal direction of the material P in a shape of the forming material P, that is, a material movement direction toward a front surface where a product resembles a letter U. A surface formed by bending in this manner is deformed from a shape of a mold due to springback, and it can be said that forming has been properly performed only when a shape of the material after springback has occurred in this manner coincides with the target shape. Through the bending forming, since the second surfaces P2 and P3 are formed from the first surface P1, by bending forming and springback, a material transfer direction, that is, when viewed from a front surface, a distance of the second faces P2 and P3 from a material center line CL is changed, and by measuring the distance, it is possible to evaluate whether the material has been properly formed. For example, when the material P is formed in FIG. 2, a distance from the material center line CL when viewed from the front surface to points A, B, C, and D of the second surfaces P2 and P3 may be measured, a distance from the center line CL to the points is changed by a degree of forming (a shape of mold) and material characteristics (springback), and by measuring the distance, it is possible to check that whether the forming has been performed into a desired shape.

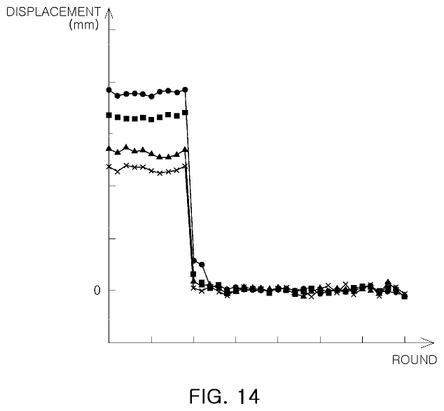

Meanwhile, when forming curvature radii r1 and r2 of the forming material P are changed, even for the same material, the degree of springback may be different. The points A, B, C, and D of FIG. 2 are four points at different positions in the left-right direction (X-direction) and forward-backward direction (Y-direction) at the same height in a formed product, and a position thereof in a height direction (Z-direction) is the same. A distance from a reference position at the corresponding position is illustrated in FIG. 14. Rounds means an order of products produced, and one product was formed in one round. Up to first 10^{th} rounds, it was formed with an initially set mold, and the mold was varied based on a shape measured after the 10^{th} rounds. As shown in FIG. 14, it can be seen that the distances measured at A, B, C, and D in the first 10^{th} rounds are all different, which means a degree of springback is different for each position, which confirms that the tendency is maintained even when the rounds change. That is, it can be seen that more springback occurs in a position where more springback occurs, and when a radius of curvature of the formed product is different, it can be confirmed that springback occurs different in the position, that distortion occurs in the formed product.

Therefore, in order to measure an accurate shape thereof even with different degrees of springback, it is necessary to measure a forming difference in a moving direction of the material (Y-direction), and the present disclosure discloses a shape checking device for a bending material that can accurately measure forming in the moving direction of the object.

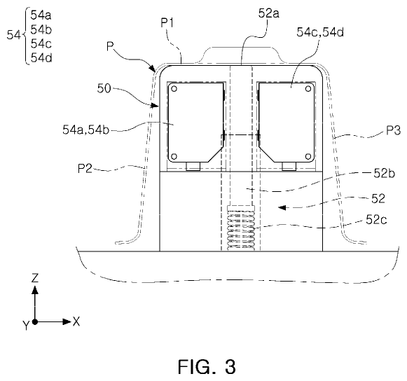

FIGS. 3 to 6 illustrate a shape checking device for a bending material according to a first embodiment of the present disclosure.

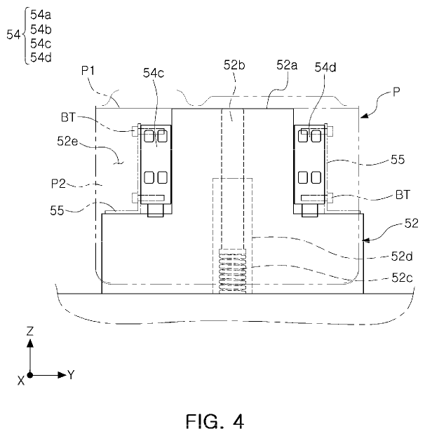

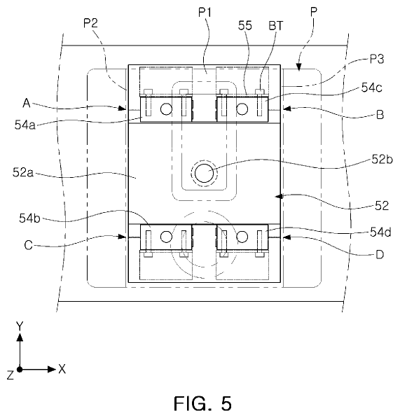

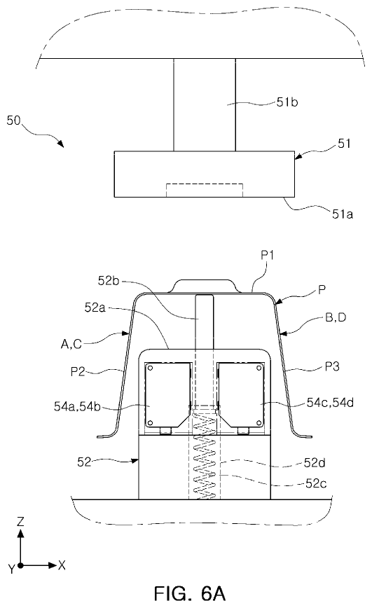

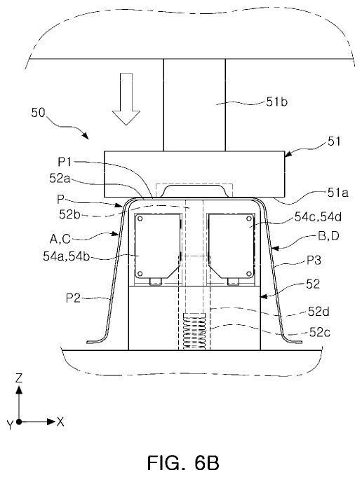

Specifically, FIG. 3 illustrates a front view of a shape checking device for a bending material 50 according to a first embodiment, FIG. 4 illustrates a side view of the shape checking device for a bending material according to a first embodiment, FIG. 5 illustrates a plan view of the shape checking device for a bending material according to a first embodiment, FIG. 6A illustrates a schematic diagram of an operation of the shape checking device for a bending material according to a first embodiment, as seen from a front surface before measurement, and FIG. 6B illustrates a schematic diagram of an operation of the shape checking device for a bending material according to a first embodiment, as seen from a front surface during measurement. As shown in FIGS. 3 to 6, the shape checking device for a bending material 50 according to a first embodiment of the present disclosure includes: a material fixing unit including a support member 52 on which a first surface P1 of a material P including a first surface P1 and second surfaces P2 and P3, bent from the first surface are seated and a pressing member 51 configured to press the first surface P1 of the material P seated on the support member; and a distance measuring unit 54 connected to the support member 52, and measuring a distance from the second surfaces P2 and P3, wherein the distance measuring unit 54 includes a first distance measuring device 54a for measuring a distance to the second surface P2, and a second measuring device 54b for measuring a distance to the second surface P2, which is the same as the second surface P2 on which a distance thereof is measured by the first distance measuring device, in a position, spaced apart from the first distance measuring device 54a in a direction, different from a bending forming direction (X-direction) of the material (Y-direction).

In addition, the distance measuring device 54 includes a third distance measuring device 54c for measuring a distance to a second surface P3, different from the second surface P2, measured by the first and second distance measuring devices 54a and 54b, and a fourth distance measuring device 54d for measuring a distance to the second surface P3, which is the same as the second surface P3 on which a distance thereof is measured by the third distance measuring device 54c, in a position spaced apart from the third distance measuring device 54c in the different direction (Y-direction).

The support member 52 is located below the material P, and fixes the material P during measurement together with the pressing member 51. The support member 52 includes a support surface 52a for supporting a material by being in contact with the first surface P1 of the material P when pressed by the pressing member 51, a support rod 52b moving together in response to movement of the pressing member 51, and supporting the material P before pressed by the pressing member 51, a spring 52c connected to the support rod 52b below the support rod 52b and providing elastic force to the support rod 52b, and an inner space 52d for accommodating the support rod 52b and the spring 52c below the support surface 52a, wherein the support surface 52a supports only a portion of the first surface P1 of the material P, not all, and an installation space 52e for installing the distance measuring unit 54 is formed in the remaining space. In a first embodiment, the support surface 52a is located in a center of the forwards-backwards direction (Y-direction) of the material, and the installation space 52e is located in front and rear of the support surface 52a. The distance measuring unit 54 is disposed in the installation space 52e, the first and third distance measurers 54a and 54c are disposed in the front installation space 52e, and the second and fourth distance measuring devices 54ba and 54d are disposed in the rear installation space 52e. Accordingly, the first and second distance measuring devices 54a and 54b and the third and fourth distance measuring devices 54c and 54d are spaced apart in the forwards-backwards direction.

The pressing member 51 is illustrated in FIGS. 6A and 6B, and includes a connection portion 51a connected to a driving means that moves up and down, for example, a press, and a pressing portion 51b compressing a material P, by being in contact with the material P. Although not illustrated, the pressing member 51 may be formed with projections or grooves for pressing the material P in place, and these projections or grooves may play a role of cooperating with cooperate with grooves or projections formed to correspond to the material P so that the material P is pressed at a predetermined position, that is, accurately fixing the material P.

The distance measuring unit 54 includes at least two distance measuring devices for measuring one surface thereof, and is coupled to the support member 52 through a bracket 55 and a bolt BT. In this embodiment, since two second surfaces are measured, the distance measuring unit 54 may include the minimum number of four distance measurers 54a to 54d, and may further include additional distance measurers.

The distance measuring devices 54a to 54d may be distance measuring devices using a laser, and measure a difference in a distance from a position of the distance measuring device to an object (second surface) or a distance from a reference distance to the object. The distance measuring device using a laser has a structure including a light emitting unit and a light receiving unit, and a detailed description thereof will be omitted. The distance measuring devices 54a to 54d are calibrated through accurately formed products after installation, and then measure the material to be formed to provide measurement results.

Since at least two distance measurers are disposed to be spaced apart from each other in a forwards-backwards direction, the distance measurer may measure distortion of the material P occurring in the forwards-backwards direction (Y-direction). That is, as mentioned above, depending on the forming shape of the material P, even if the same bending forming is performed, the springback may be different, which can be determined by measuring the formed shape in two points spaced apart in the forwards-backwards direction (Y-direction), and by providing the shape to a post-process or forming process, accurate forming can be achieved.

In a first embodiment, the first and third distance measurers 54a and 54c are disposed at the same position in the forwards-backwards direction, and the second and fourth distance measurers 54b and 54d are also disposed at the same position in the forwards-backwards direction. Therefore, in the first embodiment, it is possible to measure the forming shape of the second surfaces P2 and P3 on both sides, and the shape by springback can be measured at each position.

As shown in FIG. 6A, a material P is supplied to the support member 52 of shape checking device for a bending material 50, and in the supplied state as illustrated in FIG. 6B, a pressing member 51 comes down and the material P is fixed between the support member 52 and the pressing member 51. In a fixed state, the first to fourth distance measurers 54a to 54d measure a distance to the second surfaces P2 and P3. Thereafter, the pressing member 51 rises again, and the material P rises by the spring 52c in the same manner as before the measurement, and exits from the shape checking device for a bending material 50.

In the case of the shape checking device for a bending material 50 according to the first embodiment of the present disclosure, since the distance to the material is measured through the support member 52, the pressing member 51, and the distance measuring unit 54, and the shape of the object is determined therefrom, checks performed manually by a user may be performed quickly and accurately.

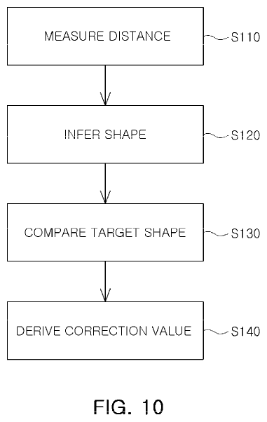

Although not illustrated, the distance measuring unit 54 is connected to a control unit, and the control unit infers a material forming shape based on a distance value measured by the distance measuring unit 54. This will be described later with reference to FIG. 10. Therefore, the control unit includes a shape inferring unit.

In addition, since distortion of the material due to springback occurring in the bending material can be accurately measured, it is possible to accurately provide a part to be corrected or improved in the forming process in the pre or post process, thereby improving overall forming accuracy.

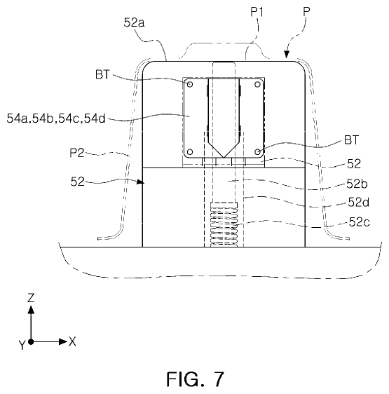

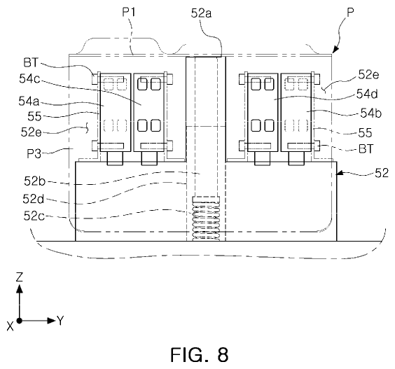

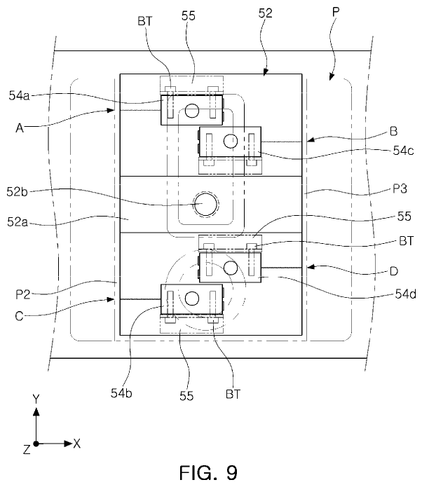

FIGS. 7 to 9 illustrate a shape checking device for a bending material 50 according to a second embodiment of the present disclosure. FIG. 7 is a front view of a front view of a shape checking device for a bending material 50 according to a second embodiment, FIG. 8 is a side view of a shape checking device for a bending material 50 according to a second embodiment, and FIG. 9 is a plan view of shape checking device for a bending material 50 according to a second embodiment.

As shown in FIGS. 7 to 9, like the first embodiment of the present disclosure, a shape checking device for a bending material 50 according to a second embodiment also includes: a material fixing unit including a support member 52 on which a first surface P1 of a material P including a first surface P1 and second surfaces P2 and P3, bent from the first surface are seated and a pressing member 51 configured to press the first surface P1 of the material P seated on the support member; and a distance measuring unit 54 connected to the support member 52, and measuring a distance from the second surfaces P2 and P3, wherein the distance measuring unit 54 includes a first distance measuring device 54a for measuring a distance to the second surface P2, and a second measuring device 54b for measuring a distance to the second surface P2, which is the same as the second surface P2 on which a distance thereof is measured by the first measuring device 54a in a position, spaced apart from the first distance measuring device 54a in a direction, different from the bending direction (X-direction) of the material (Y-direction).

The support member 52 is located below a material P, has the material P seated thereon, and fixes the material P together with the pressing member 51 during measurement. The support member 52 includes a support surface 52a for supporting a material by being in contact with the first surface P1 of the material P when pressed by the pressing member 51, a support rod 52b moving together in response to movement of the pressing member 51, and supporting the object P before being pressed by the pressing member 51, a spring 52c connected to the support rod 52b below the support rod 52b and providing elastic force to the support rod 52b, and an inner space 52d for accommodating the support rod 52b and the spring 52c below the support surface 52a, wherein the support surface 52a supports only a portion of the first surface P1 of the object P, not all, and an installation space 52e for installing the distance measuring unit 54 is formed in the remaining space. In a second embodiment, the support surface 52a is located in a center of the material in the forwards-backwards direction (Y-direction), but an area thereof may be smaller than that of the first embodiment, and an installation space 52e is located front and rear of the support surface 52a. The distance measurement unit 54 is disposed in the installation space 52e, the first and third measuring devices 54a and 54c are disposed in the front installation space 52e, and the second and fourth measuring devices 54b and 54d are disposed in the rear installation space 52e. Accordingly, the first and second distance measuring devices 54a and 54b and the third and fourth distance measuring devices 54c and 54d are spaced apart in the forwards-backwards direction (Y-direction).

Although the pressing member 51 (see FIGS. 6A and 6B

is not illustrated in FIGS. 7 to 9, the pressing member 51 is the same as the pressing member of the first embodiment, so detailed description thereof will be omitted.

The distance measuring unit 54 includes at least two distance measuring devices for measuring one surface thereof, and is coupled to the support member 52 through a bracket 55 and a bolt BT. In this embodiment, since two second surfaces are measured, the distance measuring unit 54 includes four distance measuring devices 54a to 54d, which is a minimum number thereof, and may further include additional measuring devices. The configuration of the distance measuring devices 54a to 54d is the same as that of the first embodiment, but the disposition of the distance measuring devices 54a to 54d in the second embodiment is different from that of the first embodiment.

As shown in FIG. 9, the first and second distance measurers 54a and 54b are relatively disposed outside in the forwards-backwards direction, and the third and fourth measuring devices 54c and 54d are relatively disposed inside in the forwards-backwards direction. The first distance measurer 54a is disposed outside the third distance measurer 54c, and the second distance measurer 54b is disposed outside the fourth distance measurer 54d, so that in the forwards-backwards direction, a distance between the first distance measurer 54a and the second distance measurer 54b is longer than a distance between the third distance measurer 54c and the fourth distance measurer 54d.

As in the first embodiment, in the second embodiment, since at least two distance measurers are disposed to be spaced apart from each other in the forwards-backwards direction, the distance measuring unit 54 may measure distortion of the material P occurring in the forwards-backwards direction (Y-direction). That is, as mentioned above, depending on a forming shape of the material P, even if the same bending forming is performed, the springback may be different, which may be determined by measuring the formed shaped at two points spaced apart in the forwards-backwards direction (Y-direction), and by providing the shape to a post-process or a forming process, accurate forming may be achieved.

Furthermore, in measuring the symmetrical material P, since the first to fourth distance measurers 54a to 54d measure different points in the forward and backward directions, it is possible to determine whether or not twist has occurred and what shape the distortion has occurred. That is, by determining the measurement results of the first to fourth distance measurers 54a to 54d disposed at different positions in the front-back direction, it is possible to measure a peculiar shape of the second surface, for example, even an inflated shape, shape defects that cannot be measured in Example 1 can also be determined.

Since an operation of the second embodiment is the same as that of the first embodiment, it will be replaced with the description of the first embodiment.

FIG. 10 is a flowchart of an operation of a shape measuring device for a bending material 50 of the present disclosure.

The shape measuring device for a bending material 50 according to a first embodiment or a second embodiment all includes a control unit, and the control unit is connected to a distance measuring unit 54 and another forming device (post-process-restrike device, or pre-process forming device) or a display unit. The shape measuring device for a bending material 50 measures a position measured by distance measurers 54a to 54d from the supplied material P (a position to which a laser is irradiated) and a distance of the distance measurers 54a to 54d (S110).

When a distance is measured, a shape for a bending material is inferred from the measured distance (S120). An actual shape of a measured material is inferred from a distance between distance measurers 54a to 54d and a measuring point of the measured material from a relationship between the distance between the distance measurers 54a to 54d and the measuring point in the target shape and the actual shape.

Thereafter, the target shape and the actual shape of the measured material are compared (S130), and a difference therebetween is calculated. That is, the step is similar to an operation of measuring the same through a gauge in a conventional checking device. If such a difference is derived, the difference may be displayed on the display unit and terminated. However, if there is a restrike device or a pre-process forming device, a value to be corrected for forming may be derived from the difference (S140).

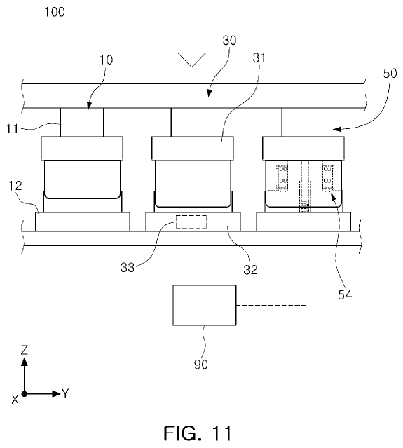

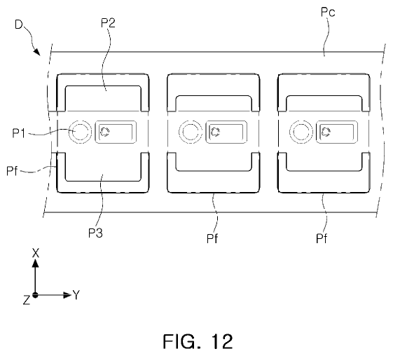

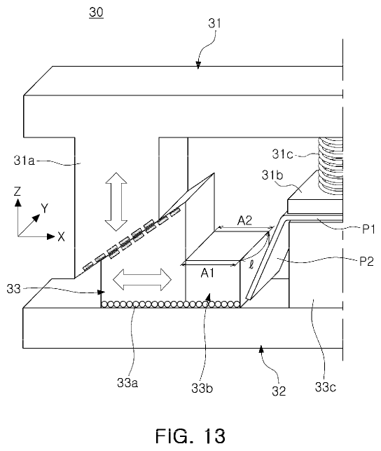

FIG. 11 illustrates a forming device 100 including a shape measuring device for a bending material 50 of the present disclosure, FIG. 12 illustrates a plan view of a material used in the forming device 100, and FIG. 13 illustrates a schematic diagram of a second forming device used in the forming device 100.

As shown in FIG. 11, the forming device 100 includes a first forming device 10 for preliminarily forming by bending a forming portion; a second device 30 disposed adjacently to the first forming device 10, and re-forming the preliminarily-formed forming portion; and a shape checking device for a bending material 50 for checking a shape of the forming portion, formed by the second forming device 20. Although not illustrated, a material transfer device for sequentially moving the material P to the first forming device 10, the second forming device 30, and the shape checking device for a bending material 50 is further included.

As shown in FIG. 12, the material P passing through the first forming device 10, the second forming device 30, and the shape checking device for a bending material 50 includes a plurality of forming portions Pf and a connection portion Pc surrounding the forming portion Pf, wherein the forming portions Pf pass through the first and second forming devices 10 and 30 and has the first surface and second surfaces P2 and P3 formed therein. A portion of the forming portions Pf, to be formed may be cut before being supplied to the first forming device 10 so as not to be attached to the connection portion Pc, and may be supplied to the first forming device 10 in a state of being cut in another facility. The material transfer device moves a material P from one device to a next device by pulling the material connected to the connection portion in one direction (right direction in FIG. 11). Each of devices 10, 30, and 50 may be connected to one press, and by performing forming and checking by each of the devices 10, 30, forming and checking may be continuously performed.

The first forming device 10 includes an upper mold 11 and a lower mold 12, and is a device for forming by bending a portion of a portion of forming portions Pf having a flat shape, and the second forming device 30 is a forming device by a cam method so that pre-forming is performed to be formed into a cam.

The second forming device 30 includes an upper mold 31 and a lower mold 33, and the lower mold is driven by a cam method to form by bending a portion formed to be bent in the first forming device 10 again. The second forming device 30 is a variable mold device capable of controlling the lower cam 33, and the lower cam 33 is connected to a control unit 90.

The shape checking device for a bending material 50 is the same device as in the first embodiment, and a detailed description thereof will be omitted, and the distance measuring unit 54 is connected to the control unit 90.

FIG. 13 illustrates a conceptual diagram of a second forming device 30 of the forming device 100. The second forming device 30 includes an upper mold 31 and a lower mold 32, and the upper mold 31 includes an upper cam 31a, a pressing plate 31b for fixing a position of a material P during forming, and a spring 31c elastically supporting the pressing plate 31b. The upper cam 31a has an inclined surface so as to convert vertical movement of a movable portion of the press body into movement in a bending forming direction (X-direction) toward the material P.

The lower mold 32 includes a seating portion 33c on which the material P is seated, and a lower cam 33 having an inclined surface corresponding to the upper cam 31a. The lower cam 33 includes a sliding structure 33a allowing movement of the lower cam 33 in the bending direction and a cam block 33b forming the material P. Actuators A1 and A2, which are spaced apart by a predetermined distance 1 from a direction in which a material of the cam block 33b moves to control a length in the bending forming direction (X-direction) are disposed. That is, the length of the cam block 33b in the bending forming direction (X-direction) may be controlled by controlling the length of the actuators A1 and A2, which makes it possible to control the cam block 33b in response to springback occurring differently in one material P according to material deviation or forming of the material P.

In this embodiment, the position of the cam block 33b is controlled by the two actuators A1 and A2, and through the position control, an overall position of the cam block 33b (position in the X-direction) may not only be controlled, but also rotation of the cam block 33b (rotation around a Z axis) may be controlled, so that distortion) that may occur in a formed product may be controlled.

Therefore, a shape of the material P passing through the second forming device 30 is measured through the shape measuring device for a bending material 50, and the actuators A1 and A2, provided on the cam block 33b of the second forming device 30 in consideration of the result, it is possible to be accurately formed. By controlling a distance of the cambler 33b in the bending forming direction (X-direction) at two points in a forward and backward direction (Y-direction) in consideration of the results of measured at two or more points in the forwards-backwards direction (Y-direction), distortion may be measured and distortion may be corrected, and it is possible to achieve accurate shape forming through accurate shape measurement beyond accurate shape measurement.

FIG. 14 illustrates a graph formed and measured by the forming device 100 of the present disclosure. First, a degree of springback was different for each position (A to D), but by controlling and forming the cam block 33b based on the measured results, a shape to be formed was quickly reached, despite a difference in an amount of springback generated at each position, it was possible to be accurately formed into the shape to be formed.

While example embodiments have been shown and described above, it will be apparent to those skilled in the art that modifications and variations could be made without departing from the scope of the present disclosure as defined by the appended claims.

1. A shape checking device for a bending material, comprising:
a material fixing unit including a support member on which a first surface of a material including a first surface and a second surface bent from the first surface is seated, and a pressing member configured to press the first surface of the material seated on the support member;
a distance measuring unit connected to the support member, and measuring a distance to the second surface,
wherein the distance measuring unit includes a first distance measuring device for measuring a distance to the second surface, and a second distance measuring device for measuring a distance to a second surface, identical to the second surface on which a distance thereof is measured by the first distance measuring device, in a position spaced apart from the first distance measuring device in a first direction, different from a bending forming direction of a material.

2. The shape checking device for a bending material of claim 1, further comprising:
a shape inferring unit connected to the distance measuring unit, and inferring a shape of a material from a result measured by the distance measuring unit,
wherein the shape inferring unit calculates distortion generated in a material based on a result measured by the first distance measuring device and a result measured by the second distance measuring device.

3. The shape checking device for a bending material of claim 1, wherein the second surface is provided on both sides of the first surface,
wherein the distance measuring unit further comprises
a third distance measuring device for measuring a distance to a second surface, different from the second surface measured by the first and second measuring devices and a fourth distance measuring device for measuring a distance to a second surface, which is the same as the second surface on which a distance thereof is measured by the third distance measuring device, in a position, spaced apart from the third distance measuring device in the first direction.

4. The shape checking device for a bending material of claim 1, wherein, in the first direction, a distance between the first and second distance measuring devices is different from a distance between the third and fourth distance measuring devices,
and positions of the first to fourth distance measuring devices in the first direction are different from each other.

5. The shape checking device for a bending material of claim 3, wherein the first and third distance measuring devices are disposed in the same position in the first direction, and the second and fourth distance measuring devices are also disposed in the same position in the first direction.

6. The shape checking device for a bending material of claim 3, wherein the first to fourth distance measuring devices are laser distance measuring devices.

7. The shape checking device for a bending material of claim 1, wherein the material comprises a forming portion formed to be bent and a connection portion surrounding the forming portion and connecting neighboring forming portions, and
a material traveling direction in which the material is supplied and discharged to the shape checking device for the bending material is the first direction.

8. A forming machine for continuously forming and checking a shape of a material including a plurality of forming portions and a connection portion surrounding the forming portions,
the forming machine, comprising:
a first forming device for preliminarily forming by bending a forming portion;
a second forming device disposed adjacently to the preliminarily-formed device and re-forming the preliminarily-formed forming portion;
a shape checking device for checking a shape of the forming portion, formed by the second forming device; and
a material transfer device for sequentially moving the material to a first forming device, a second forming device, and the shape checking device; includes,
wherein the shape checking device is a shape checking device for a bending material of claim 7,
wherein the second forming device includes a forming control unit for controlling a degree of bending forming in at least at two points, spaced apart with respect to one surface in a direction of transfer of the material in consideration of a measurement value of the shape checking device.

9. The forming device of claim 8, wherein the shape checking device and the second forming device are connected to the same control unit,
wherein the control unit is configured to infer a shape of a material in consideration of a measurement result, and controls the forming control unit according to the inferred result.

10. The forming device of claim 9, wherein the shape checking device, and the first and second forming devices are connected to the same press.
